(19) United States
(12) Patent Application Publication
(10) Pub. No.: US 2020/0410502 A1
(43) Pub. Date: Dec. 31, 2020

(54) SYSTEM HAVING IMAGING APPARATUS TO RECOGNIZE USERS AND PROCESS FARE CHARGING, CONTROL METHOD OF SYSTEM, AND STORAGE MEDIUM

(71) Applicant: CANON KABUSHIKI KAISHA, Tokyo (JP)

(72) Inventor: Junji Kawata, Tokyo (JP)

(21) Appl. No.: 16/910,719

(22) Filed: Jun. 24, 2020

(30) Foreign Application Priority Data
Jun. 27, 2019 (JP) 2019-120043

(51) Int. Cl. G06Q 20/40; G06K 9/00; G06Q 20/08; G06Q 10/10; G07B 15/00

(52) U.S. Cl. CPC G06Q 20/40145; G06K 9/00288; G07B 15/00; G06Q 20/085; G06Q 10/107; G06K 9/00771

(57) ABSTRACT

A system includes an image-capturing unit configured to capture an image in a predetermined region that accommodates a plurality of persons passing through, an identification unit configured to identify the plurality of persons based on respective faces of the plurality of persons included in an image generated by the image-capturing by the image-capturing unit, and a charging unit configured to charge the plurality of persons identified by the identification unit respective fares that are chargeable to the plurality of persons.

### FIELD

One disclosed aspect of the embodiments relates to a system, a control method of the system, and a storage medium.

### DESCRIPTION OF THE RELATED ART

There is a system in which a person pays a fare by bringing a card or a wristwatch close to a reading unit.

For example, there is a system of opening a ticket gate at a station by bringing a recharged card close to the reading unit on the ticket gate.

Japanese Patent Application Laid-Open No. 2005-135059 discusses a system of opening a gate if captured face image data matches with pre-registered face image data.

However, since a range in which ticket gate can read information is narrow, a person has to cautiously hold the card or the wristwatch over the reading unit to present information read by the reading unit.

In addition, the narrow passage limits the number of people who can pass through the gate and necessitates the formation of a queue at the gate. This situation may cause inconvenience to customers and create inefficiency in processing customers' information.

A conventional ticket gate system includes a gate, and causes the user to hold the card over the reading unit to pay a fare.

FIG. 11 is a diagram illustrating the conventional ticket gate system viewed from the above.

Gate control units 1001 and 1003 illustrated in FIG. 11 include gates 1005 and 1006, respectively, and control the gates 1005 and 1006, respectively, to open by the user holding the card over the reading unit and paying the fare. The user passes through the gates upward in FIG. 11 at two columns on the left side, and the user passes through the gates downward in FIG. 11 at two columns on the right side. Each user is represented by a circle (e.g., user 1002).

The reading unit is capable of reading out information from the card in a narrow range of about 3 cm, so that the user needs to bring the card within 3 cm of the reading unit. Thus, the user needs to cautiously bring the card close to the reading unit. Further, when the user fails to make the card read by the reading unit, the user is blocked by the gates 1005 and 1006 and is brought to a stand. As a result, a queue is formed.

### SUMMARY

According to an aspect of the embodiments, a system includes an image-capturing unit, an identification unit, and a charging unit. The image-capturing unit is configured to capture an image in a predetermined region that accommodates a plurality of persons passing through. The identification unit is configured to identify the plurality of persons based on respective faces of the plurality of persons included in an image generated by the image-capturing by the image-capturing unit. The charging unit is configured to charge the plurality of persons identified by the identification unit respective fares that are chargeable to the plurality of persons.

Further features of the disclosure will become apparent from the following description of exemplary embodiments with reference to the attached drawings.

### BRIEF DESCRIPTION OF THE DRAWINGS

FIG. 1 is a diagram illustrating a configuration of a system according to an exemplary embodiment.

FIG. 2 is a diagram illustrating a configuration of a network camera according to the present exemplary embodiment.

FIG. 3 is a diagram illustrating a configuration of a fare determination server according to the present exemplary embodiment.

FIG. 4 is a diagram illustrating a configuration of a payment server according to the present exemplary embodiment.

FIG. 5 is a diagram illustrating a ticket gate according to the present exemplary embodiment.

FIG. 6 is a flowchart of processing according to the present exemplary embodiment.

FIG. 7 is a flowchart of processing according to the present exemplary embodiment.

FIG. 8 is a flowchart of processing according to the present exemplary embodiment.

FIG. 9 is a flowchart of processing according to the present exemplary embodiment.

FIG. 10 is a flowchart of processing according to the present exemplary embodiment.

FIG. 11 is a diagram illustrating the prior art.

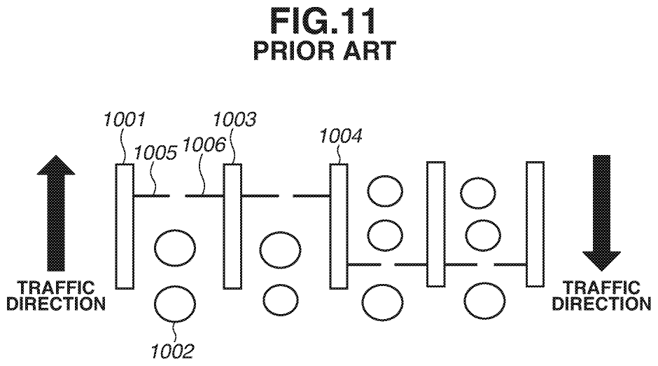

### DESCRIPTION OF THE EMBODIMENTS

An exemplary embodiment to carry out the disclosure will be described below with reference to the accompanying drawings.

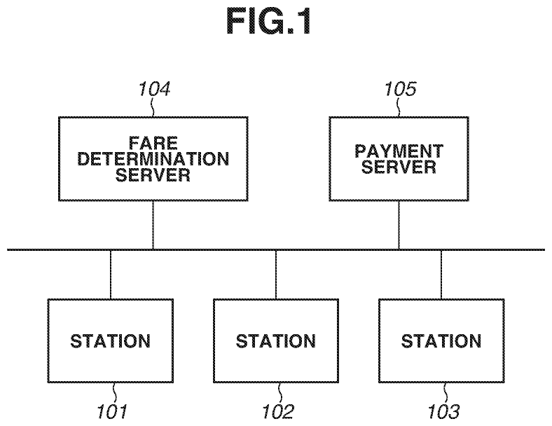

A first exemplary embodiment will be described below. FIG. 1 is a diagram illustrating a configuration of a system according to the present exemplary embodiment.

The system according to the present exemplary embodiment includes a plurality of stations including stations 101 to 103, a fare determination server 104, and a payment server 105. A network camera inside the station 101, a network camera inside the station 102, a network camera inside the station 103, the fare determination server 104, and the payment server 105 are connected to one another through a network. While the present exemplary embodiment is described using an example of three stations, the number of stations only needs to be two or more, and is not limited to three.

Each of the stations 101 to 103 is a station at which trains stop and users get on or off the trains.

The fare determination server 104 is a server that determines a fare to be paid by, or chargeable to, a user based on a predetermined rule. The fare determination server 104 determines a fare when a user gets on a train at the station 101 and gets off the train at the station 102, and a fare when a user gets on a train at the station 101 and gets off the train at the station 103. The fare determination server 104 transmits the determined fare, together with user information, to the payment server 105, and charges the user the fare.

The payment server 105 deducts the charged fare from the user's account identified based on the user information.

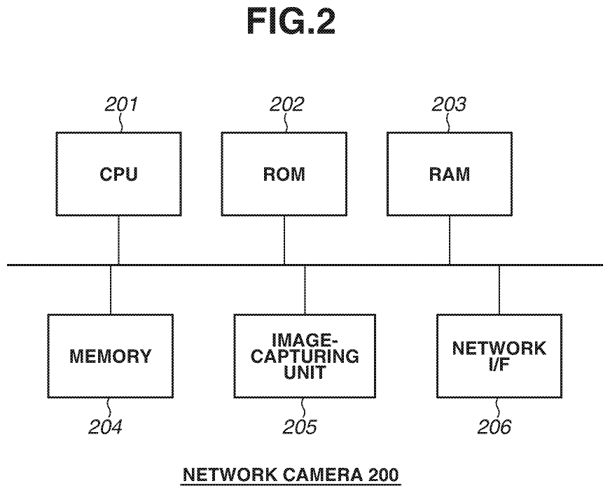

FIG. 2 is a block diagram illustrating a configuration of a network camera 200 installed at each station.

A Central Processing Unit (CPU) 201 performs centralized control over the network camera 200.

A read-only memory (ROM) 202 is a computer-readable memory, and stores a program read out by the CPU 201.

A random-access memory (RAM) 203 functions as a work area for the CPU 201.

A memory 204 stores an image captured by an image-capturing unit 205.

The image-capturing unit 205 includes a lens, and captures a moving image in a predetermined range. The image-capturing unit 205 may be capable of capturing an image.

A network interface (I/F) 206 is connected to the network and controls communication with the network.

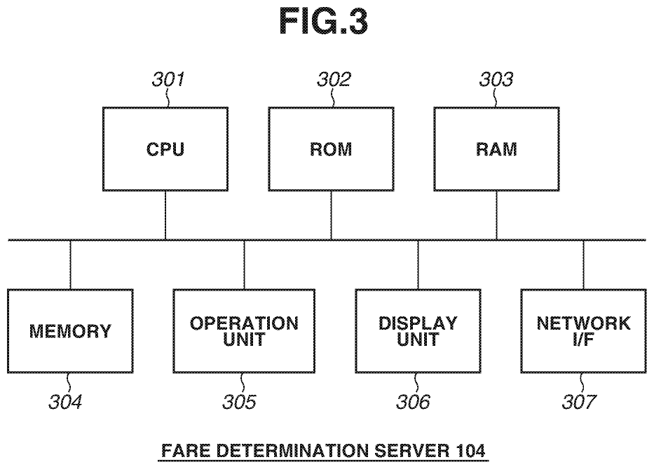

FIG. 3 is a block diagram illustrating a configuration of the fare determination server 104.

A CPU 301 performs centralized control over the fare determination server 104.

A ROM 302 stores a program read out by the CPU 301.

A RAM 303 functions as a work area for the CPU 301.

A memory 304 stores a database to determine a fare chargeable to a user based on a departure station and an arrival station. For example, the memory 304 stores, for example, a fare chargeable to a person who gets on a train at the station 101 and gets off the train at the station 102, and a fare chargeable to a person who gets on a train at the station 101 and gets off the train at the station 103, as the database.

An operation unit 305 includes, for example, a mouse and a keyboard, and accepts an operation by the user.

A display unit 306 displays an operation screen and a variety of information.

A network I/F 307 is connected to the network and controls communication with the network.

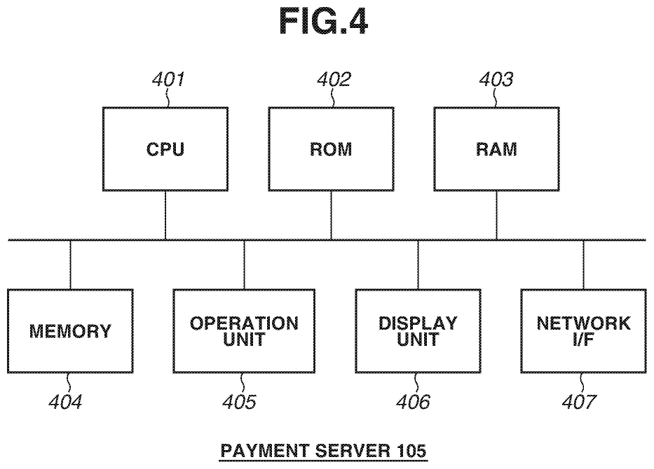

FIG. 4 is a block diagram illustrating a configuration of the payment server 105.

A CPU 401 performs centralized control over the payment server 105.

A ROM 402 stores a program read out by the CPU 401.

A RAM 403 functions as a work area for the CPU 401.

A memory 404 manages the available balance for each user. Further, the memory 404 stores the user's balance, and the user's address and email address in association with information indicating the user.

An operation unit 405 includes, for example, a mouse and a keyboard, and accepts an operation by the user.

A display unit 406 displays an operation screen and a variety of information.

A network I/F 407 is connected to the network and controls communication with the network.

With the configuration described above, the present exemplary embodiment is directed to providing a system of eliminating time spent to hold a card or a wristwatch over a reading unit, and preventing formation of a queue.

The present exemplary embodiment has been made in view of such an issue, and is directed to providing the system of eliminating time spent to hold the card or the wristwatch over the reading unit, and preventing formation of a queue.

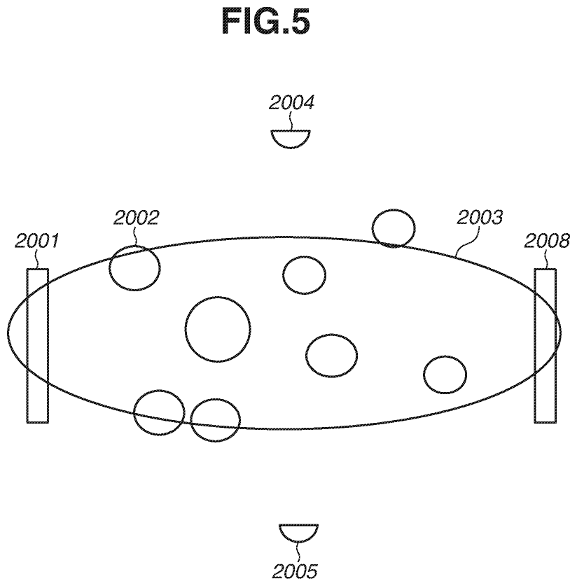

FIG. 5 is a diagram illustrating one form of the system according to the present exemplary embodiment. Such a system as is illustrated in FIG. 5 is installed at each station.

The user can pass between partitions 2001 and 2008 illustrated in FIG. 5. Each user is represented by a circle (e.g., user 2002). The user moves between the partitions 2001 and 2008 downward or upward of FIG. 5. When the user goes to a platform to get on a train, the user moves between the partitions 2001 and 2008 upward of FIG. 5. In contrast, when the user gets off the train and leaves a station, the user moves between the partitions 2001 and 2008 downward of FIG. 5.

A network camera 2004 is a camera to capture an image of the face of the user passing between the partitions 2001 and 2008 upward of FIG. 5. A network camera 2005 is a camera to capture an image of the face of the user passing between the partitions 2001 and 2008 downward of FIG. 5.

An image-capturing region 2003 is a region in which the network camera 2004 can capture an image. The region 2003 may be a region through which a plurality of persons can pass together or simultaneously. The network camera 2004 or the network camera 2005 captures an image of the face of a person who passes through the image-capturing region 2003.

A plurality of faces corresponding to a plurality of persons is image-captured in an image captured by the network camera 2004 or the network camera 2005, and recognizes the faces at the same time. The technology discussed in Japanese Patent Application Laid-Open No. 2017-46290, for example, may be used as a technology to recognize a plurality of faces at the same time and identify users corresponding to the respective faces.

For example, if a user 1, who has been image-captured by the network camera 2004 at a station 1, is image-captured by the network camera 2005 at a station 2, the user 1 is charged a fare X.

If the user 1, who has been image-captured by the network camera 2004 at the station 1, is image-captured by the network camera 2005 at a station 3, the user 1 is charged a fare Y.

In order to achieve such a system, the network camera 2004 (first image-capturing unit) at the station 101 captures an image in the image-capturing region 2003 first. The network camera 2004 then transmits, to the fare determination server 104, face information in the captured image, information indicating the station 101 (name of station 101), and information indicating that a purpose of the user passing through the image-capturing region 2003 at the station 101 is to get on a train.

Thereafter, the network camera 2005 (second image-capturing unit) at the station 102 captures an image in the image-capturing region 2003. The network camera 2005 then transmits, to the fare determination server 104, face information in the captured image, information indicating the station 102 (name of station 102), and information indicating that a purpose of the user passing through the image-capturing region 2003 at the station 102 is to get off the train.

The fare determination server 104 identifies a fare chargeable to the user who gets off the train at the station 102 based on the transmitted information. The fare determination server 104 transmits the identified fare and user information to the payment server 105.

The payment server 105 stores a resultant of subtracting the fare chargeable to the user from information about the balance in an account of the user indicated by the transmitted user information.

When the balance is below zero as a result of subtracting the fare that is chargeable, the CPU 301 notifies a predetermined destination (e.g., email address registered for user) about a message indicating the insufficient balance and a shortfall.

In order to use such a system, the user makes a registration first to associate the user information with an account in the payment server 105 in advance.

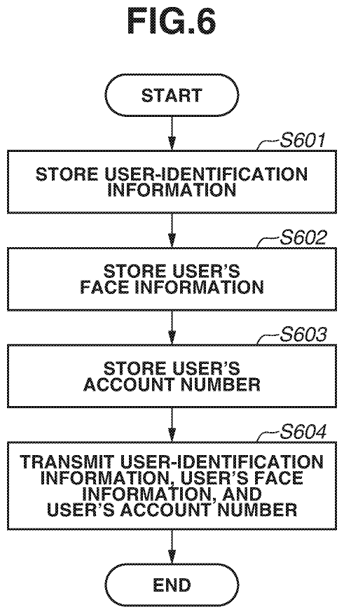

A flowchart illustrated in FIG. 6 is to register the user information in advance.

The user goes to a wicket, or a service window, at any one of the stations 101 to 103, and asks a clerk at the wicket to apply for the registration of the user information. First, the user writes user-identification information and the user's account number in an application form and submits it to the clerk at the wicket.

The clerk at the wicket uses a keyboard of a personal computer (PC) in the wicket to input the user-identification information. In step S601, the PC stores the input user-identification information in a storage unit in the PC. Information from which the user can be uniquely identified is used for the user-identification information. Examples of the user-identification information include My Number (also called as Social Security and Tax Number).

The clerk at the wicket uses a camera installed at the wicket to capture an image of the face of the user, and inputs face information to the PC. In step S602, the PC stores the input face information in association with the user-identification information stored in step S601.

The clerk at the wicket inputs the user's account number to the PC. In step S603, the PC stores the input account number of the user in association with the user-identification information registered in step S601.

In step S604, when accepting a registration instruction from the clerk at the wicket, the PC transmits the information stored in steps S601 to S603 and a request for registration to the fare determination server 104.

The CPU 301 in the fare determination server 104 registers the user-identification information, the user's face information, and the user's account number in association with one another in the memory 304. Table 1 below indicates an example of associated information. Table 1 is hereinafter referred to as a user information table.

TABLE 1

| | | | | |
|---|---|---|---|---|
| USER-IDENTIFICATION | USER'S FACE | USER'S ACCOUNT | DEPARTURE | ARRIVAL |
| INFORMATION | INFORMATION | NUMBER | STATION | STATION |

| | | | |
|---|---|---|---|
| USER A | 11111111111 | 011110 . . . 011 | xxxxxxxxxxxxxxxx |
| USER B | 22222222222 | 101100 . . . 011 | yyyyyyyyyyyyyyyy |
| USER C | 33333333333 | 100000 . . . 001 | zzzzzzzzzzzzzzzz |
| . . . | | | |

The user's face information is the face information acquired by image-capturing at the wicket and stored as digital data.

The user has created an account in the payment server 105 in advance, so that when the payment server 105 receives a request for payment from the fare determination server 104, a charged fare can be subtracted from the balance in the account with the user's account number. Information about the created account includes the user information, the account number, and the balance, and is stored in the memory 404 in the payment server 105. The balance increases by the user depositing money to the account in advance.

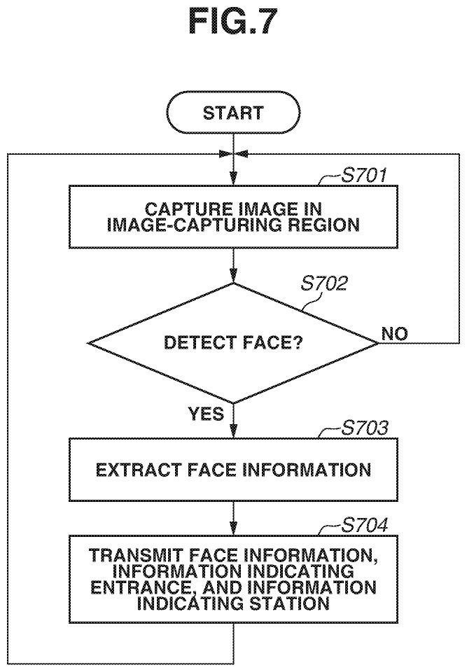

FIG. 7 is a flowchart illustrating processing of the network camera 2004 installed at the station 101. Each processing in the flowchart in FIG. 7 is achieved by the CPU 201 of the network camera 2004 at the station 101 loading a program stored in the ROM 202 to the RAM 203 and executing the program. A similar network camera 2004 is installed at each of the stations 102 and 103.

In step S701, the CPU 201 controls the image-capturing unit 205 to capture an image in the image-capturing region 2003. At this time, the image-capturing unit 205 can capture an image of the faces of a plurality of persons at the same time to generate image data including the faces of the persons by the image-capturing.

In step S702, the CPU 201 analyses the image captured by the image-capturing unit 205 to determine whether the face of a person has been detected. When the face of the person has been not detected (No in step S702), the processing returns to step S701. In contrast, when the face of the person has been detected (Yes in step S702), the processing proceeds to step S703.

In step S703, the CPU 201 extracts the person's face information in the image captured by the image-capturing unit 205. When faces of a plurality of persons are included, the CPU 201 extracts the persons' face information.

In step S704, the CPU 201 transmits, to the fare determination server 104, the face information extracted in step S703, information indicating entrance, and information indicating a station at which the network camera 2004 is installed. In step S704, when information about faces of a plurality of persons have been extracted in step S703, the CPU 201 transmits, to the fare determination server 104, the persons' face information, the information indicating the entrance, and the information indicating the station at which the network camera 2004 is installed. The information indicating the station may be registered as a station name in the memory 204 of the network camera 2004 when the network camera 2004 is installed at the station. The name of the station may be registered from a PC connected to the network camera 2004 through the network. Whether the information indicating the entrance is transmitted and whether information indicating exit is transmitted may also be registered in the memory 204 of the network camera 2004 when the network camera 2004 is installed at the station. Since the network camera 2004 is a camera installed at a position and angle so as to capture an image of a user who enters a platform at the station, the information indicating the entrance may be registered in the memory 204 of the network camera 2004 when the network camera 2004 is installed at the station. The information indicating the entrance may be registered from a PC connected to the network camera 2004 through the network.

When the processing in step S704 ends, the processing returns to step S701.

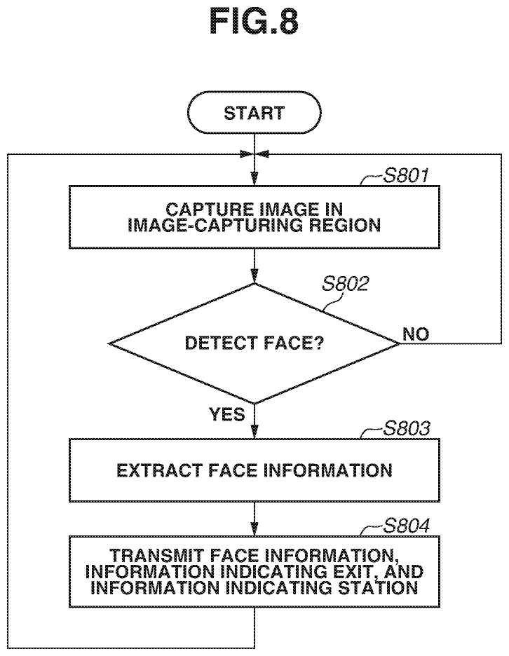

FIG. 8 is a flowchart illustrating processing of the network camera 2005 installed at the station 101. Each process in the flowchart in FIG. 8 is achieved by the CPU 201 of the network camera 2005 at the station 101 loading a program stored in the ROM 202 to the RAM 203 and executing the program. A similar network camera 2005 is installed at each of the stations 102 and 103.

In step S801, the CPU 201 controls the image-capturing unit 205 to capture an image in the image-capturing region 2003. At this time, the image-capturing unit 205 can capture an image of the faces of a plurality of persons at the same time to generate image data including the faces of the persons by the image-capturing.

In step S802, the CPU 201 analyses the image captured by the image-capturing unit 205 to determine whether the face of a person is detected. When the face of the person has been not detected (No in step S802), the processing returns to step S801. In contrast, when the face of the person has been detected (Yes in step S802), the processing proceeds to step S803.

In step S803, the CPU 201 extracts the person's face information in the image captured by the image-capturing unit 205. When faces of a plurality of persons are included, the CPU 201 extracts the persons' face information.

In step S804, the CPU 201 transmits, to the fare determination server 104, the face information extracted in step S803, the information indicating the exit, and the information indicating the station at which the network camera 2005 is installed. In step S804, the CPU 201 transmits to the fare determination server 104, when information about faces of a plurality of persons have been extracted in step S803, the persons' face information, the information indicating the entrance, and the information indicating the station at which the network camera 2005 is installed. The information indicating the station may be registered as the name of the station in the memory 204 of the network camera 2005 when the network camera 2005 is installed at the station. The name of the station may be registered from a PC connected to the network camera 2005 through the network. Whether the information indicating the entrance is transmitted and whether information indicating exit is transmitted may also be registered in the memory 204 of the network camera 2005 when the network camera 2005 is installed at the station. Since the network camera 2005 is a camera installed at a position and angle so as to capture an image of a user who exits a platform at the station, the information indicating the exit may be registered in the memory 204 of the network camera 2005 when the network camera 2005 is installed at the station. The information indicating the exit may be registered from a PC connected to the network camera 2005 through the network.

When the processing in step S804 ends, the processing returns to step S801.

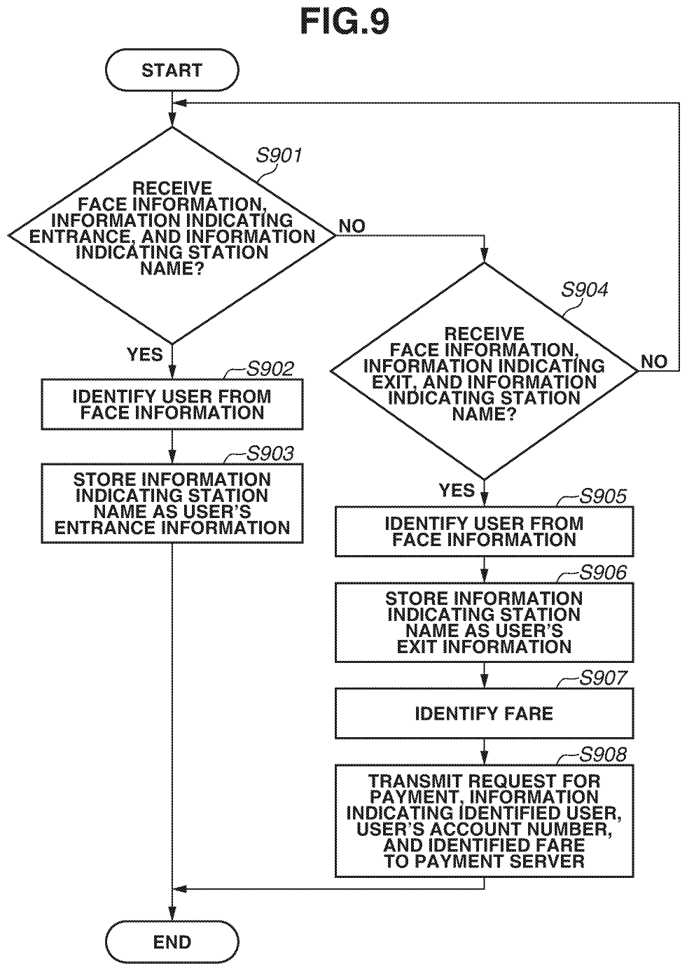

FIG. 9 is a flowchart illustrating processing of the fare determination server 104. Each process in the flowchart in FIG. 9 is achieved by the CPU 301 in the fare determination server 104 loading a program stored in the ROM 302 to the RAM 303 and executing the program.

In step S901, the CPU 301 determines whether the face information, the information indicating the entrance, and the information indicating the station name have been received through the network. When the CPU 301 determines that the face information, the information indicating the entrance, and the information indicating the station name have been received (Yes in step S901), the processing proceeds to step S902. When the CPU 301 determines that the face information, the information indicating the entrance, and the information indicating the station name have not been received (No in step S901), the processing proceeds to step S904.

In step S902, the CPU 301 searches the user information table (Table 1), which has been registered in advance, for the received face information, and identifies the user who enters the platform at the station. In step S902, when information about faces of a plurality of e persons is included, the CPU 301 identifies the individual persons from the persons' face information.

In step S903, the CPU 301 stores the received information indicating the station name as information about entrance of the user identified in step S902 in the user information table in the memory 304. For example, when users A and B enter the platform at the station at the same time, the CPU 301 stores the “station 101” in a field of a departure station of each of the users A and B in the user information table.

TABLE 2

| | | | | |
|---|---|---|---|---|
| USER-IDENTIFICATION | USER'S FACE | USER'S ACCOUNT | DEPARTURE | ARRIVAL |
| INFORMATION | INFORMATION | NUMBER | STATION | STATION |

| | | | | |
|---|---|---|---|---|
| USER A | 11111111111 | 011110 . . . 011 | xxxxxxxxxxxxxxxx | STATION 101 |
| USER B | 22222222222 | 101100 . . . 011 | yyyyyyyyyyyyyyyy | STATION 101 |
| USER C | 33333333333 | 100000 . . . 001 | zzzzzzzzzzzzzzzz | |
| . . . | | | | |

In step S904, the CPU 301 determines whether the face information, the information indicating the exit, and the information indicating the station name have been received through the network. When the CPU 301 determines that the face information, the information indicating the exit, and the information indicating the station name have been received (Yes in step S904), the processing proceeds to step S905. When the CPU 301 determines that the face information, the information indicating the exit, and the information indicating the station name have not been received (No in step S904), the processing returns to step S901.

In step S905, the CPU 301 searches the user information table (Table 1), which has been registered in advance, for the received face information, and identifies the user who exits the platform at the station. In step S905, when information about faces of a plurality of persons is included, the CPU 301 identifies the individual persons from the persons' face information.

In step S906, the CPU 301 stores the received information indicating the station name as information about the exit of the user identified in step S905 in the user information table in the memory 304. For example, when the user A travels from the station 101 to the station 102, and exits the platform at the station 102, the CPU 301 stores the “station 102” in a field of an arrival station of the user A in the user information table.

TABLE 3

| | USER-IDENTIFICATION | USER'S FACE | USER'S ACCOUNT | DEPARTURE | ARRIVAL |
|---|---|---|---|---|---|
| | INFORMATION | INFORMATION | NUMBER | STATION | STATION |
| USER A | 11111111111 | 011110 . . . 011 | xxxxxxxxxxxxxxxx | STATION 101 | STATION 102 |
| USER B | 22222222222 | 101100 . . . 011 | yyyyyyyyyyyyyyyy | STATION 101 | |
| USER C | 33333333333 | 100000 . . . 001 | zzzzzzzzzzzzzzzz | | |
| . . . | | | | | |

In step S907, the CPU 301 identifies a fare chargeable to the user identified in step S905, based on the information indicating the station name stored in step S903, the information indicating the station name stored in step S906, and a fare table stored in the memory 304. The CPU 301 identifies 500 yen as a fare to be charged to the user A, who gets on a train at the station 101 and gets off a train at the station 102. In step S907, when information about faces of a plurality of persons is included in step S904, the CPU 301 identifies respective fares chargeable to the persons. Table 4 is an example of the fare table.

TABLE 4

| DEPARTURE STATION | ARRIVAL STATION | FARE |
|---|---|---|
| STATION 101 | STATION 102 | 500 |
| STATION 101 | STATION 103 | 800 |
| STATION 102 | STATION 103 | 400 |

In step S908, the CPU 301 transmits, to the payment server 105 through the network, a request for payment, the information indicating the user identified in step S905, the user's account number, and the fare identified in step S906. In step S908, when information about faces of a plurality of persons is included in step S907, the CPU 301 transmits a request for payment of respective fares chargeable to the persons.

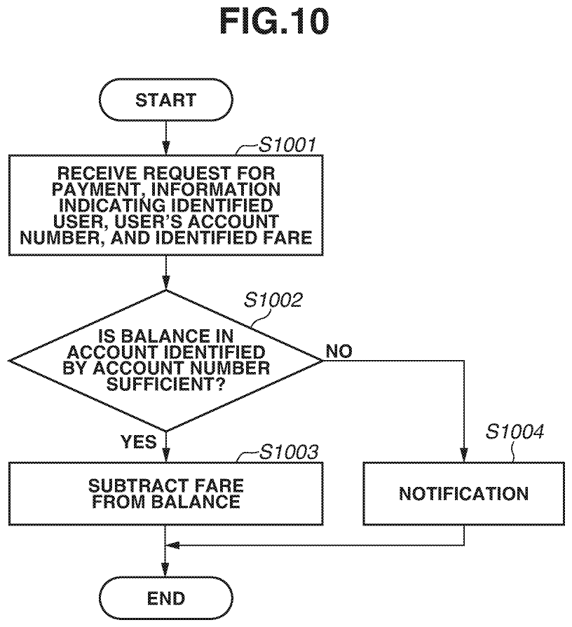

FIG. 10 is a flowchart illustrating processing of the payment server 105. Each process in the flowchart in FIG. 10 is achieved by the CPU 401 of the payment server 105 loading a program stored in the ROM 402 to the RAM 403 and executing the program.

In step S1001, the CPU 401 receives, through the network, the request for payment, the information indicating the user, and the information indicating the fare that is chargeable.

In step S1002, the CPU 401 compares the balance in the account identified by the received account number of the user and the fare that is chargeable to determine whether the balance is sufficient. When the CPU 401 determines the balance is sufficient (Yes in step S1002), the processing proceeds to step S1003. When the CPU 401 determines the balance is insufficient (No in step S1002), the processing proceeds to step S1004. When receiving the request for payment of the respective fares chargeable to a plurality of persons in step S1001, the CPU 401 compares the respective balances in the accounts identified by the respective account numbers of the persons and the respective fares chargeable to the persons to determine whether the balances are sufficient.

In step S1003, the CPU 401 stores a resultant of subtracting the fare chargeable to the user from the balance in the account identified by the received account number of the user. When receiving the request for payment of the respective fares chargeable to the persons in step S1001, the CPU 401 stores in the memory 404 resultants of subtracting the respective fares chargeable to the persons from the respective balances of the accounts identified by the respective account numbers of the persons.

In step 1004, the CPU 401 identifies an email address of the user identified by the received information indicating the user from the information stored in the memory 404, and transmits a message indicating the insufficient balance to the email address. In step S1001, when receiving the request for payment of the respective fares chargeable to a plurality of persons, the CPU 401 transmits the messages indicating the insufficient balance and respective shortfalls to be paid by the persons to respective email addresses registered in advance for the persons.

The system described above provides advantageous effects as follows. The present exemplary embodiment can eliminate a hindrance to a passage, for example, between the gate control units 1003 and 1004 and between the gates 1005 and 1006 as much as possible, thereby capable of providing the system of eliminating time spent to hold the card or the wristwatch over the reading unit, and preventing formation of a queue.

### Other Exemplary Embodiment

While the example has been described in which one network camera 2004 and one network camera 2005 are installed, a plurality of network cameras 2004 and a plurality of network cameras 2005 may be installed.

In this case, information acquired by image-capturing by the network cameras 2004 is transmitted multiple times. When the information indicating the entrance is transmitted to the fare determination server 104 multiple times, the fare determination server 104 may ignore the information indicating the entrance for the second time or later. Further, information acquired by image-capturing by the network cameras 2005 is transmitted multiple times. When the information indicating the entrance is transmitted to the fare determination server 104 multiple times, the fare determination server 104 may ignore the information indicating the entrance for the second time or later.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-120043, filed Jun. 27, 2019, which is hereby incorporated by reference herein in its entirety.

What is claimed is:

1. A system, comprising:
an image-capturing unit configured to capture an image in a predetermined region that accommodates a plurality of persons passing through;
an identification unit configured to identify the plurality of persons based on respective faces of the plurality of persons included in an image generated by the image-capturing by the image-capturing unit; and
a charging unit configured to charge the plurality of persons identified by the identification unit respective fares that are chargeable to the plurality of persons.

2. The system according to claim 1,
wherein the image-capturing unit is installed at a station;
wherein the identification unit is configured to identify the plurality of persons who exit a platform of the station based on the respective faces of the plurality of persons who exit the platform of the station, and
wherein the charging unit is configured to charge the plurality of persons who exit the platform of the station the respective fares that are chargeable to the plurality of persons.

3. The system according to claim 1, further comprising:
a storage unit configured to store a balance for each person; and
a notification unit configured to make notification to a predetermined destination in a case where a fare charged by the charging unit to a person who exits a platform of a station is higher than the balance stored for the person in the storage unit.

4. The system according to claim 3, wherein the predetermined destination is an email address registered for the person who exits the platform of the station.

5. A system, comprising:
a first image-capturing unit configured to capture an image of a face of a person who enters a platform of a first station;
a first reception unit configured to receive a name of the first station at which the person enters the platform of the first station;
a second image-capturing unit configured to capture an image of a face of a person who exits a platform of a second station;
a second reception unit configured to receive a name of the second station at which the person exits the platform of the second station;
an identification unit configured to identify the person who exits the platform of the second station based on the image of the face captured by the second image-capturing unit; and
a charging unit configured to charge the person identified by the identification unit a fare that are chargeable to the person based on information indicating the first station received by the first reception unit and information indicating the second station received by the second reception unit.

6. The system according to claim 5, further comprising:
a storage unit configured to store a balance for each person; and
a notification unit configured to make notification to a predetermined destination in a case where the fare charged by the charging unit to the person identified by the identification unit is higher than the balance stored for the person in the storage unit.

7. The system according to claim 6, wherein the predetermined destination is an email address registered for the person who exits the platform of the second station.

8. A control method of a system, comprising:
identifying a plurality of persons based on respective faces of the plurality of persons included in an image generated by image-capturing in a predetermined region that accommodates the plurality of persons passing through; and
charging the identified plurality of persons respective fares that are chargeable to the plurality of persons.

9. The control method of the system according to claim 8, further comprising making notification to a predetermined destination in a case where a fare charged to a person who exits a platform of a station is higher than a balance stored for the person.

10. The control method of the system according to claim 9, wherein the predetermined destination is an email address registered for the person who exits the platform of the station.

11. A non-transitory computer-readable storage medium that causes a system to execute a control method, the control method comprising:
identifying a plurality of persons based on respective faces of the plurality of persons included in an image generated by image-capturing in a predetermined region that accommodates the plurality of persons passing through; and
charging the identified plurality of persons respective fares that are chargeable to the plurality of persons.
